(19) United States
(12) Patent Application Publication
(10) Pub. No.: US 2013/0254024 A1
(43) Pub. Date: Sep. 26, 2013

(54) Systems and Methods for Cross-Platform Software Bundling

(71) Applicants: Daniel J. Woods, Santa Cruz, CA (US); Maxine Manafy, Palo Alto, CA (US)

(72) Inventors: Daniel J. Woods, Santa Cruz, CA (US); Maxine Manafy, Palo Alto, CA (US)

(73) Assignee: BUNNDLE, INC., Palo Alto, CA (US)

(21) Appl. No.: 13/426,562

(22) Filed: Mar. 21, 2012

(51) Int. Cl. G06Q 30/02

(52) U.S. Cl. 705/14.51

(57) ABSTRACT

Systems and methods are provided to enable bundling of software applications across multiple, disparate platforms, such as for example, bundling PC applications with mobile applications. The system enables mobile application developers to make offers to publishers of PC software to compensate the publishers for presenting advertisements for mobile application developers' product offerings during the installation of the publishers product offerings on user PCs. The publishers integrate an offer manager into their installation packages. When the installation packages are installed on a user's PC, the offer manager communicates with a software bundling service and identifies relevant offers, such as, for example, offers made by mobile application developers that are partnered with the software publisher supplying the installation package. Relevant offers are then presented to the user on the users PC, and if accepted, a download URL for a mobile user's application is transmitted to a user mobile device.

### FIELD OF THE TECHNOLOGY

At least some embodiments disclosed herein relate, in general, to systems for bundling software downloads, and more particularly for bundling software downloads across multiple platforms including, without limitation, mobile devices.

### BACKGROUND

Software is commonly distributed to users via downloads over the Internet. When a user downloads and installs a particular software application on a user device, it can indicate the user may be interested in other software applications. Thus, when the software application is installed, the user can be provided an opportunity to download and install other software applications, creating a potentially lucrative business opportunity. Users commonly have multiple devices. When a user installs a software application on one of his or her devices, for example a stationary workstation, it can indicate the user may have an interest in other software applications on other devices, for example, a mobile application for a mobile device.

### BRIEF DESCRIPTION OF THE DRAWINGS

The embodiments are illustrated by way of example and not limitation in the figures of the accompanying drawings in which like references indicate similar elements.

FIG. 1 shows a conceptual illustration of the operation of an embodiment of the present disclosure relating to a cross-platform software bundle including a PC application and a mobile application.

FIG. 2 illustrates one embodiment of window displayed by a user PC when an application installation process is initiated on a user PC.

FIG. 3 illustrates one embodiment of an offer window displayed on a user PC that displays an advertisement for a bundled mobile application offer.

FIG. 4 illustrates one embodiment of a window displayed on a user PC that enables a user to enter a phone number for a mobile device to which a message including a download URL for a bundled mobile application offer is to be transmitted.

FIG. 5 illustrates one embodiment of a window displayed on a user PC that displays a confirmation that a user has accepted an offer for bundled a mobile application offer and that the user's mobile device will receive an SMS message including a download URL for the offer.

FIG. 6 illustrates one embodiment of an SMS message sent to a user's mobile device that includes a hyperlink for a download URL to download and install a bundled mobile application on the mobile device.

FIG. 7 illustrates an embodiment of a high-level overview of a software bundling service provider and a network configuration through which the provider interacts with users and software publishers and advertisers.

FIG. 8 shows a block diagram of a data processing system, which can be used in various embodiments of the disclosed systems and methods.

FIG. 9 shows a block diagram of a user device according to one embodiment.

FIG. 10 illustrates one embodiment of a method for software publishers and advertisers to cooperate in bundling software offerings.

FIG. 11 illustrates an embodiment of an advertiser campaign including login and relevant data of the advertiser's software application.

FIGS. 12a-c illustrates one embodiment of a method a method for presenting a cross-platform offer for a mobile application bundled, via a software bundling service, with a PC application.

### DETAILED DESCRIPTION

The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Various embodiments of the systems and methods disclosed herein provide a software bundling service that includes a distribution platform and exchange for downloadable software applications. In an embodiment, the software bundling service provides facilities to enable publishers of software applications to monetize their audience through bundling the publishers' software with software offered by advertisers for a fee. In an embodiment, the software bundling service provides facilities to advertisers of software applications to acquire access to a wider audience by bundling their software offerings with software offered by software publishers.

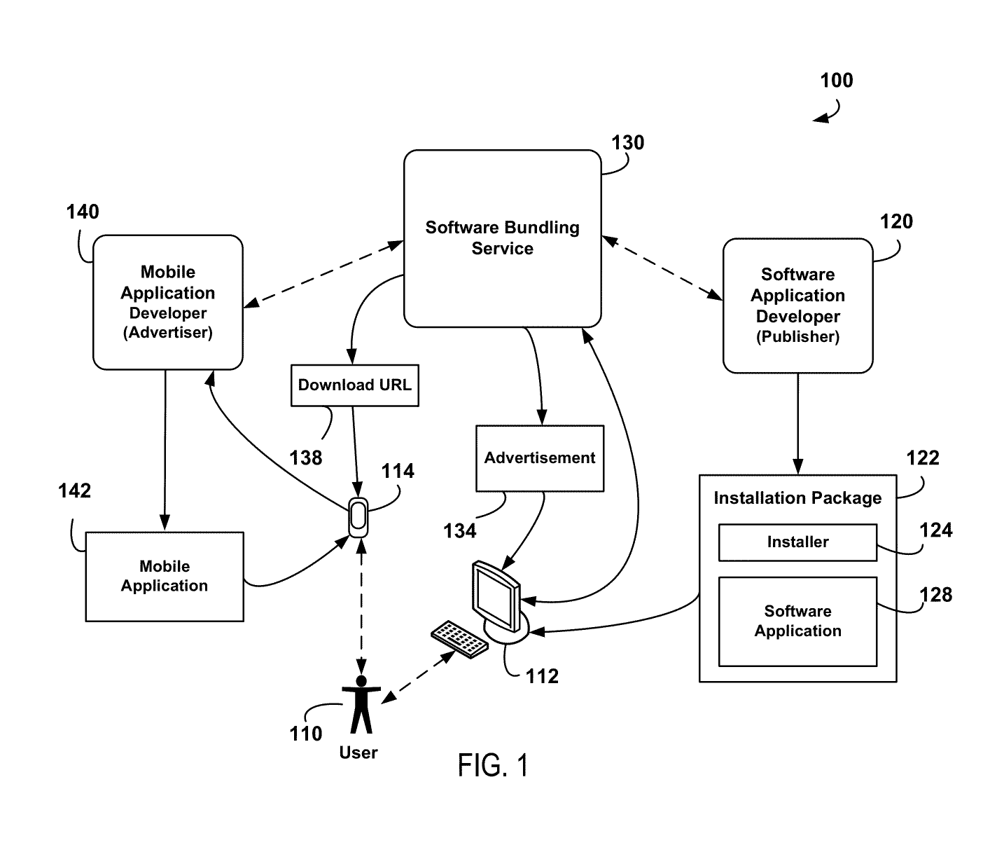

For the purpose of the present disclosure, in an embodiment, a software bundle should be understood to refer to a collection of software offered to an individual end user. For example, if a user downloads software for the SKYPE voice-over-Internet Protocol service, the user may also see an offer to download the GOOGLE CHROME browser alongside of SKYPE. The two software offers together constitutes a “bundle”. The present disclosure relates, in particular, to cross-platform software bundling, which is to say, software bundles where bundled applications reside on multiple, disparate platforms. For example, in an embodiment, a cross-platform software bundle may bundle a PC application with an application for a mobile device, as illustrated in FIG. 1.

FIG. 1 shows a conceptual illustration of the operation of an embodiment of the present disclosure relating to a cross-platform software bundle including a PC application and a mobile application.

A user 110 has two devices, one device is a stationary desktop PC 112 and the other device is a mobile phone 114. The two devices 112 and 114 shown are purely illustrative, and it should be understood that the user 110 could have any number of devices, and such devices could be any type of computing device or mobile device capable of connecting to a network, such as, for example, the Internet. A user device may, for example, comprise a desktop computer or a portable device, such as a cellular telephone, a smart phone, a display pager, a radio frequency device, an infrared device, a personal digital assistant, a handheld computer, a tablet computer, a laptop computer, a set top box, or a wearable computer.

In the illustrated embodiment, the user 110 has obtained a software installation package 122 from a software application developer (publisher) 120 for the purpose of installing a software application 124 on the user's PC 112. The software application 124 could represent any type of software application of interest to the user 110 such as, for example, web browsers and/or web browser add-ins, office applications, games and so forth. In various embodiments, the user 110 may have obtained the installation package through any conventional means such as, for example, by downloading the installation package 122 directly to the user's PC 112 over the Internet or by loading the installation package 122 to the PC from a computer-readable medium such as, for example, a CD or a DVD.

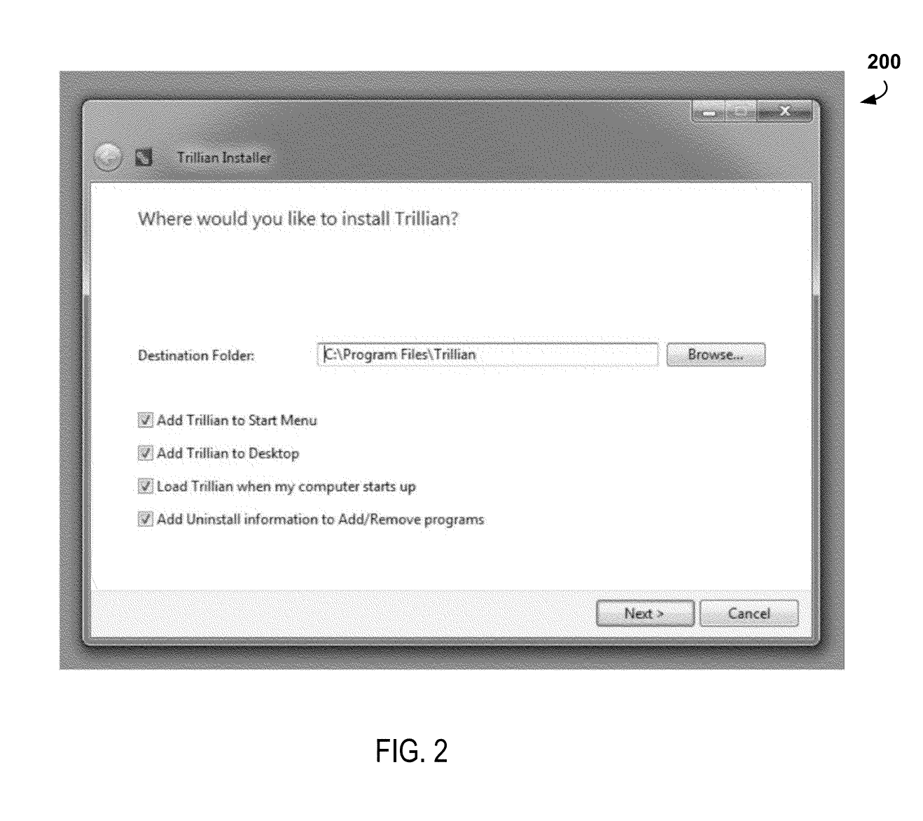

In the illustrated embodiment, the user 110 initiates an installation process on the user's PC 112 using the installation package 122. In an embodiment, an installer 124 within the installation package 122 executes and installs the software application 128 on the user's PC 112. In an embodiment, the installation process initially displays a conventional installation window such as, for example, the installation window 200 shown in FIG. 2.

Referring back to FIG. 1, in an embodiment, the installer 124 incorporates a module (not shown) provided by a software bundling service 130, hereinafter referred to as the “offer manager”. In an embodiment, at a point in the installation process, for example, after the software application 128 is successfully installed on the user's PC, the offer manager gathers information from the user's 110 PC 112 relating to the user 110 and the PC 112 and transmits the information to the software bundling service 130.

The software bundling service 130 then determines, using the information relating to the user 110 and the PC 112, if there are any outstanding product offerings that should be presented to the user 110. In the illustrated embodiment, a mobile application developer 140 is registered with the software bundling service 130 and has defined an advertiser offer for a mobile application 142 with the service. In an embodiment, the advertiser offer includes criteria for selecting users that the mobile application developer 140 wishes to target, and additionally includes a bid amount the developer is willing to pay to publishers to present the advertiser offer to users. In an embodiment, the software bundling service 130 goes through the various offers to select only those offers that qualify and are relevant based on the matching criteria.

In the illustrated embodiment, the software application developer 120 is registered with the software bundling service 130 as a publisher, has selected the mobile application developer 140 as a partner, and has selected the advertiser offer for the mobile application 142 as an offer the software application developer 120 is willing to present to users installing the developer's software application 128 on their PCs.

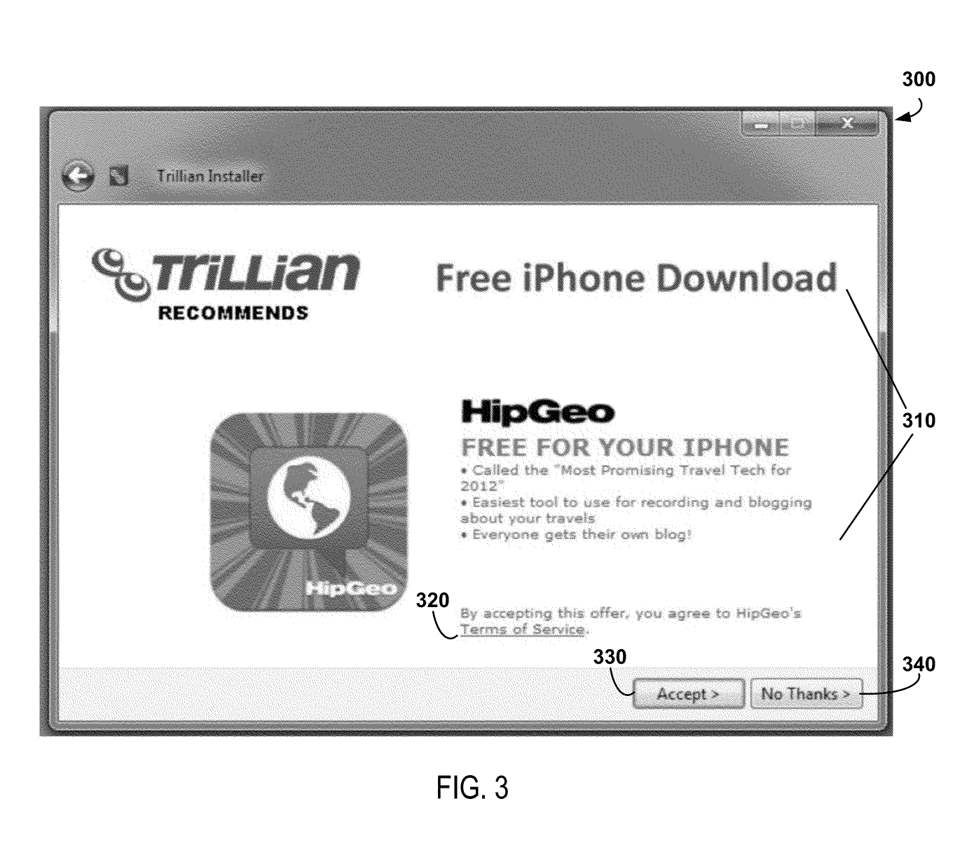

In an embodiment, the software bundling service 130, using the information relating to the user 110 and the PC 112, filters available offers and identifies the most relevant advertiser offer to present to the user. In the illustrated embodiment, the advertiser offer relating to the mobile application 142 is selected as the most relevant offer to present to the user. The software bundling service then transmits an advertisement 134 for the selected advertiser offer to the user's 110 PC. The user's 110 PC 112 displays the advertisement in a window such as, for example, the advertisement window 300 illustrated in FIG. 3.

In the illustrated embodiment, the advertisement window 300 displays a description of the offer 310. The advertisement window further provides a hyperlink 320 to a webpage that displays terms of service for the mobile application that is the subject of the offer. Typically, this webpage is located on a website of the mobile application developer. The advertisement window 300 further provides user interface controls that enable the user 110 to accept 330 or decline the offer. If the user 110 declines 340 the offer, the installation process ends.

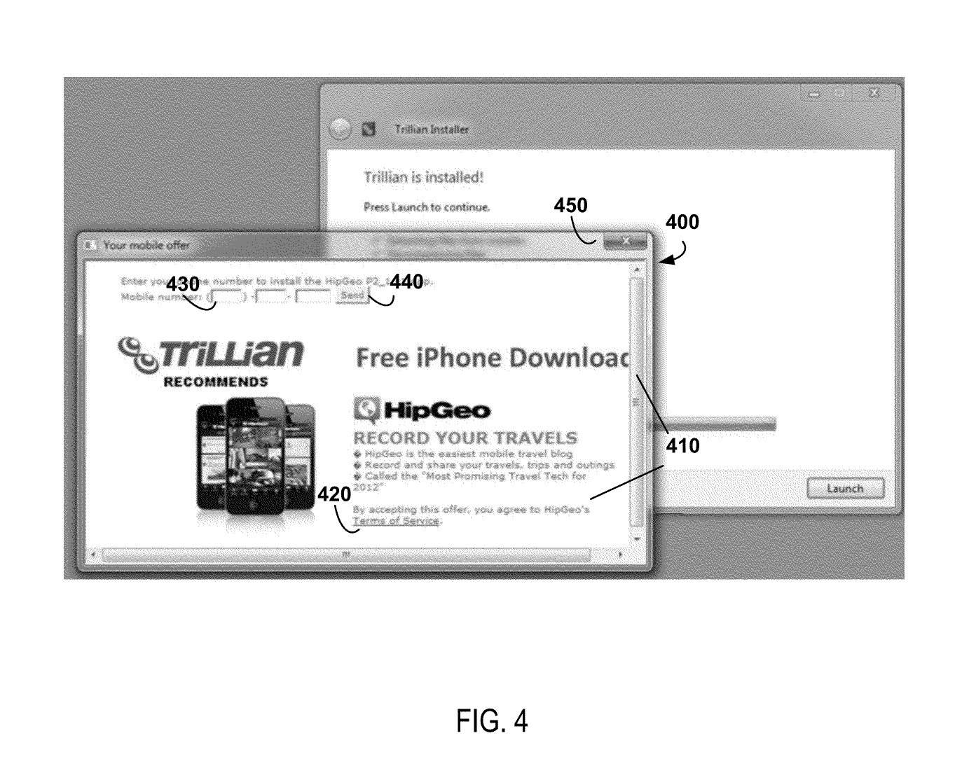

Referring back to FIG. 1, in the illustrated embodiment, the user 110 accepts the offer. In response, the software bundling service launches a PC-to-mobile intermediary application on the user's 110 PC 112 that prompts the user 110 for a phone number for a mobile device, for example, the mobile device 114. In an embodiment, the PC-to-mobile intermediary application displays a mobile phone number entry window such as shown in FIG. 4. In the illustrated embodiment, the mobile phone number entry window 400 redisplays the offer details 410 and the hyperlink 420 to the terms of service.

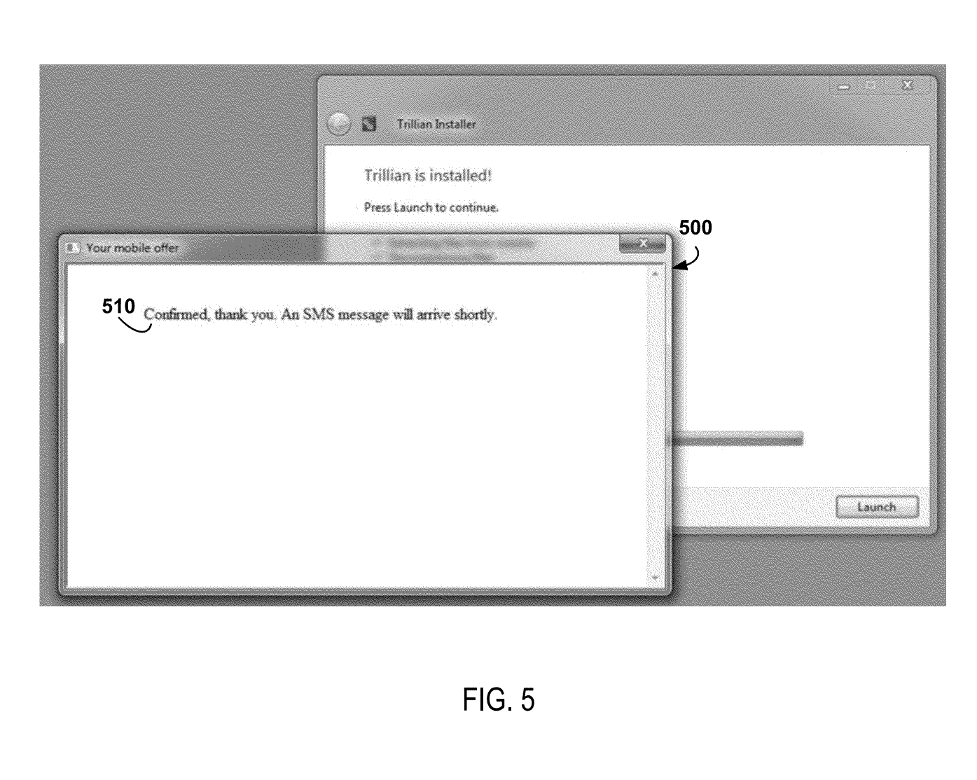

In the illustrated embodiment, the user 110 enters a phone number for the user's mobile device 114 in the text entry boxes 430 provided by the window 400 and clicks on the send button 440, sending the phone number of the user's 110 mobile device to the software bundling service 130. In an embodiment, the PC-to-mobile intermediary application on the user's 110 PC 112 then displays a confirmation window such as shown in FIG. 5. In the illustrated embodiment, the confirmation window 500 displays a simple message 510 that confirms the user's 110 transmission of the phone number of the user's 110 mobile device 114 and notifies the user to expect an SMS message relating to the offer on the user's 110 mobile device 114. Alternatively, if the user 110 elects to close the window 400 using the close button 450 on the window 400, the installation process terminates, and no data is sent to the software bundling service.

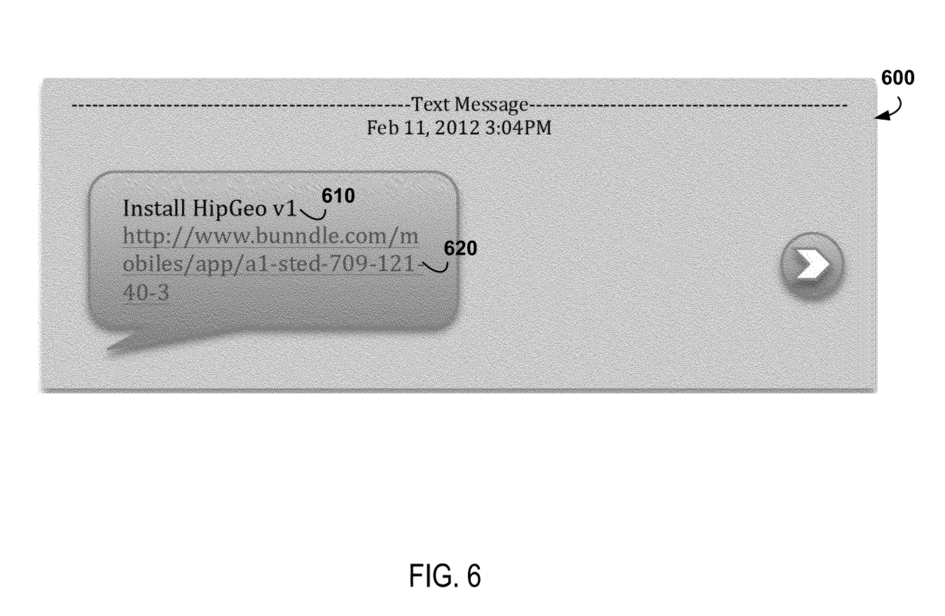

Referring back to FIG. 1, in the illustrated embodiment, the software bundling service 130 receives the phone number of the mobile device 114 and, in response, transmits a text message 138 containing a download URL for the mobile application 142 to the user's 110 mobile device 114. In an embodiment, the text message 138 is an SMS message, although in various other embodiments, the text message 138 could be sent to the user via any conventional means suitable for the transmission of text data such as, for example, in an email. FIG. 6 illustrates one embodiment of a text message 600 for installing a mobile application on the user's 110 mobile device 114. In the illustrated embodiment, the text message 600 includes a brief title 610 for the offer and provides a hyperlink 620 for the offer. In an embodiment, the hyperlink 620 is a link to the software bundling service 130 and additionally comprises an identification of the offer.

In an embodiment, if the user 110 clicks on the hyperlink 620 using the user's 110 mobile device 114, the user's 110 mobile device 114 first links to the software bundling service, and if the software bundling service determines the user's 110 mobile device 114 is the correct platform for the mobile application 142, the user's 110 mobile device is then redirected to the appropriate mobile application store from which to download and install the mobile application 142, for example, a application store or download site operated by the mobile application developer 140.

In an embodiment, the software bundling service 130 charges the mobile application developer 140 a fee for presenting the advertiser offer relating to the mobile application 142 to the user 110. In an embodiment, the mobile application developer 140 is charged a fee for presenting the advertiser offer relating to the mobile application 142 to the user 110 only if the user 110 accepts the offer or installs the mobile application 142 on the user's mobile device 114. In various embodiments, a portion of the fee is remitted to software application developer 120 and a portion of the fee may be retained by the software bundling service 130, as discussed in detail below.

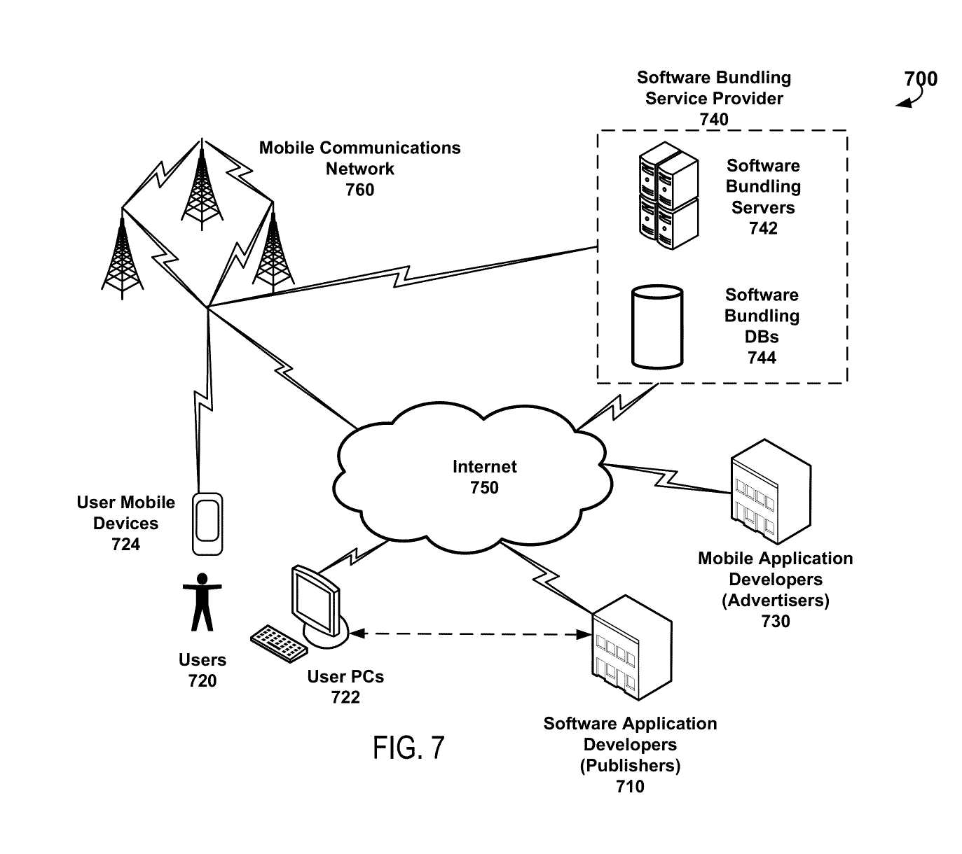

FIG. 7 illustrates an embodiment of a high-level overview of a software bundling service provider and a network configuration through which the provider interacts with users and software publishers and advertisers.

In the illustrated embodiment, a number of software application developers (publishers) 710, for example, developers of various types of software for PCs, provide software to users 720 interested in the developer's 710 products. In an embodiment, the software application developers 710 provide software to users in the form of software installation packages (not shown). In an embodiment, users 720 may download software installation packages for the software developer's 710 products, over the Internet 750, to their respective PCs 722, for example, via a website provided by the developer 710 or a third-party download service (not shown). In an embodiment, users 720 may load software installation packages for the software developer's 710 products to their respective PCs 722 from a computer-readable medium provided by the software developer 710, for example, a CD or a DVD. Note that the term “PC” is used in its broadest sense, and could relate to, among other things, various processor configurations (e.g. single, dual or quad) and various operating systems (e.g. Windows, Mac OS, UNIX, Linux and so forth).

In an embodiment, mobile application developers 730 may wish to increase their market share for their mobile applications by bundling their mobile application offerings with software developers' 710 products that are targeted to other platforms such as, for example user 722 PCs. It should be understood that in various embodiments, the mobile application developers 730 may be the actual developer of mobile applications, or a marker or reseller of mobile applications. In an embodiment, the mobile application developers 730 register with a software bundling service provider 740 that provides cross-platform bundling services.

In an embodiment, the mobile application developers 730 register with the software bundling service provider 740 over the Internet 750 using facilities hosted on software bundling servers 742 such as, for example, a self-serve website. In an embodiment, after registering with the software bundling service provider 740, the mobile application developers 730 define advertising campaigns and advertiser offers using facilities hosted on software bundling servers 742 such as, for example, a self-serve website, as described in detail below. In an embodiment, advertiser offers defined by the mobile application developers 730 comprise open offers for compensation to any software application developer 710 that allows the mobile application developers' 730 offerings to be bundled with software application developers' 710 offerings. In an embodiment, information relating to mobile application developers 730, including registration information and information relating to advertising campaigns and advertiser offers, is stored on one or more software bundling databases 744.

In an embodiment, software application developers 710 may desire to generate additional revenue by bundling their offerings with offerings by other software application providers, including, but necessarily not limited to mobile application offerings from mobile application developers 730. In an embodiment, the software application developers register as publishers with the software bundling service provider 740 over the Internet 750 using facilities hosted on software bundling servers 742 such as, for example, a self-serve website. In an embodiment, after registering with the software bundling service provider 740, the software developers 710 select one or more mobile application developers 730 as partners and select one or more advertiser offers offered by its partners using facilities hosted on software bundling servers 742 such as, for example, a self-serve website, as described in detail below. In an embodiment, information relating to software developers 710, including registration information and the developers' partners and selected offers, is stored on one or more software bundling databases 744.

In an embodiment, the software developers 710 then integrate an offer manager module supplied by the software bundling service provider 740 into the software developers 710 software installation packages. When users 720 initiate installation of a software developer's 710 installation package that incorporates the software bundling service provider's 740 offer manager module on their respective PCs 722, the offer manager module gathers information from the users' 720 PCs 722 and transmits such information, over the Internet 750, to software bundling processes running on software bundling servers 742, as described in detail below. In an embodiment, the software bundling processes match information from the user's PC to active advertiser offers and select offers to present to users 720. In an embodiment, software bundling processes running on software bundling servers 742 then transmit information relating to selected offers, including advertisements for such offers, over the Internet 750, to users' 720 PCs 722, which display the advertisements.

In an embodiment, when a user 720 accepts an advertiser offer for a bundled mobile application, the user provides a phone number for a mobile device 724 of the user 720 of to the offer manage running on the user's 720 PC 722, which transmits the phone number, over the Internet 750, to software bundling processes running on software bundling servers 742. In response, software bundling processes running on software bundling servers 742 transmit a message, over a mobile communications network 760, to the user's mobile device 724, for example, an SMS message, that includes a URL for downloading and installing a mobile application associated with the advertiser offer the user has accepted. In an embodiment, the URLs in the messages comprise a hyperlink to the software bundling service provider 740 and an identification of a selected offer.

In an embodiment, when a users 720 clicks on the URL using the user's mobile device 724, the device 724 is connected, via the mobile communications network 760, and via the Internet 750, to the software bundling service provider 740. In response, software bundling processes running on software bundling servers 742 verify that user's mobile device 724 represents a valid platform for the mobile application that is the subject of the selected offer, and if it is, the user's mobile device is redirected to a mobile application store or download site from which the mobile application can be downloaded and installed. In an embodiment, such a mobile application store or download site may be hosted by the mobile application developer 730, the software bundling service provider 740 or a third party (not shown).

In various embodiments, there are multiple techniques that can be used to detect attributes of an end user's mobile device 724 based on information on their other computing devices, for example, their PCs 722. These techniques can include: (1) the existence and usage of software such as, for example, iTunes that indicate an iOS device, (2) the existence of software applications used in conjunction with particular mobile devices 724, (3) the existence of browser cookies and history indicating visits, searches, purchases from one or more app stores for a particular type of mobile device 724, (4) browser cookies and history indicating frequent usage of online backup and archive services such as, for example, iCloud, of data particular to a type of device 724, (5) software applications and local backups and archives of data and metadata on the user's PC 722, such as music formats or application backups that indicate use of a particular device. In addition the negation of any of the above conditions increases the probability that a particular mobile device 724 is not used by the user 720. In an embodiment, once the software bundling service provider 740 has determined a user's mobile device 724 type software bundling service provider 740 can associate GUIDs (a unique identifier created by the service) of users' 720 PCs 722 with that device type on software bundling DBs.

In an embodiment, software bundling processes running on software bundling servers 742, charge mobile application developers 730 fees for presenting the mobile application developers' advertiser offerings to users 720, and credit software developers at least a portion of such fees for allowing mobile application developers' 730 offerings to be bundled with their software application offerings, as described in detail below

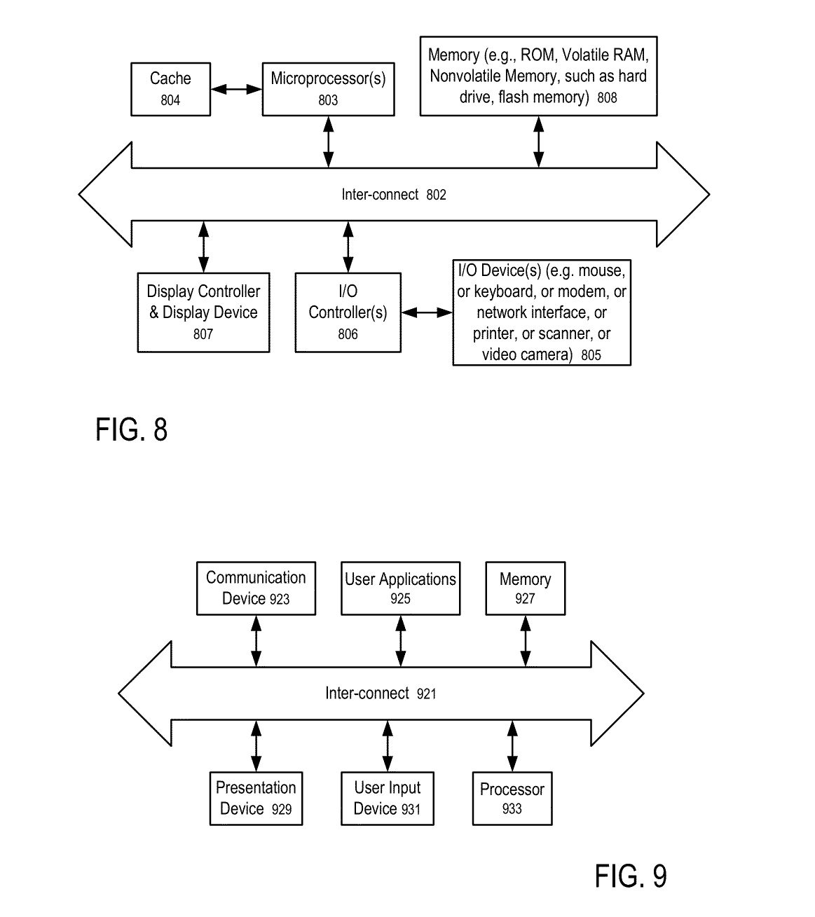

FIG. 8 shows a block diagram of a data processing system, which can be used in various embodiments of the disclosed systems and methods. While FIG. 8 illustrates various components of a computer system, it is not intended to represent any particular architecture or manner of interconnecting the components. Other systems that have fewer or more components may also be used.

In FIG. 8, the system 801 includes an inter-connect 802 (e.g., bus and system core logic), which interconnects a microprocessor(s) 803 and memory 808. The microprocessor 803 is coupled to cache memory 804 in the example of FIG. 8.

The inter-connect 802 interconnects the microprocessor(s) 803 and the memory 808 together and also interconnects them to a display controller and display device 807 and to peripheral devices such as input/output (I/O) devices 805 through an input/output controller(s) 806. Typical I/O devices include mice, keyboards, modems, network interfaces, printers, scanners, video cameras and other devices that are well known in the art.

The inter-connect 802 may include one or more buses connected to one another through various bridges, controllers and/or adapters. In one embodiment the I/O controller 806 includes a USB (Universal Serial Bus) adapter for controlling USB peripherals, and/or an IEEE-1394 bus adapter for controlling IEEE-1394 peripherals.

The memory 808 may include ROM (Read Only Memory), and volatile RAM (Random Access Memory) and non-volatile memory, such as hard drive, flash memory, etc.

Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In an embodiment, the software bundling servers 742 of FIG. 7 are implemented using one or more data processing systems as illustrated in FIG. 8. In some embodiments, one or more servers of the system illustrated in FIG. 8 are replaced with the service of a peer-to-peer network or a cloud configuration of a plurality of data processing systems, or a network of distributed computing systems. The peer-to-peer network, or cloud based server system, can be collectively viewed as a server data processing system.

Embodiments of the disclosure can be implemented via the microprocessor(s) 803 and/or the memory 808. For example, the functionalities described above can be partially implemented via hardware logic in the microprocessor(s) 803 and partially using the instructions stored in the memory 808. Some embodiments are implemented using the microprocessor(s) 803 without additional instructions stored in the memory 808. Some embodiments are implemented using the instructions stored in the memory 808 for execution by one or more general-purpose microprocessor(s) 803. Thus, the disclosure is not limited to a specific configuration of hardware and/or software.

FIG. 9 shows a block diagram of a user device, such as the devices 112 and 114 of FIGS. 1 and 722 and 724 of FIG. 7 according to one embodiment. In FIG. 9, the user device includes an inter-connect 921 connecting a communication device 923, such as a network interface device, a presentation device 929, such as a display screen, a user input device 931, such as a keyboard or touch screen, user applications 925 implemented as hardware, software, firmware or a combination of any of such media, such various user applications (e.g. apps), a memory 927, such as RAM or magnetic storage, and a processor 933 that, inter alia, executes the user applications 925.

In one embodiment, the user applications implement one or more user interfaces displayed on the presentation device 929 that provides users the capabilities to, for example, access the Internet, send and receive messages and/or receive and display offers transmitted by a software bundling service provider such as the provider 740 of FIG. 7. In one embodiment, the user applications uses the communication device to communicate with software bundling servers such as that shown in 742 of FIG. 7 to provide user and user device data to processes on software bundling servers and to receive data from software bundling servers relating to advertiser offers,

In one embodiment, users use the user input device 931 to interacts with the device via the user applications 925 supported by the device, for example, by accessing and interacting with websites, messages and offers described in detail above with respect to FIGS. 1 and 2. The user input device 931 may include a text input device, a still image camera, a video camera, and/or a sound recorder, etc.

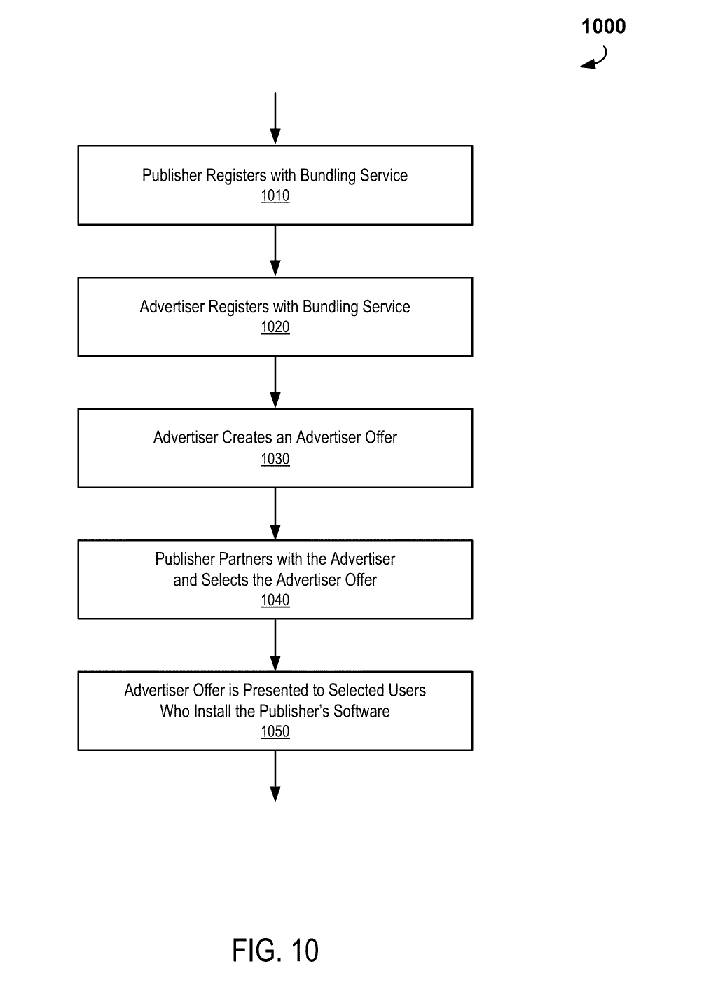

FIG. 10 illustrates one embodiment of a method for software publishers and advertisers to cooperate in bundling software offerings. In one embodiment, one or more servers such as the software bundling service servers shown in 742 of FIG. 7 perform the operations of the method shown in FIG. 10, and software bundling service databases such as that shown in 744 of FIG. 7 store the data collected and utilized by the method.

In the first operation of the method, one or more processes running on a server enable a software publisher to register 1010, over a network, with a software bundling service. In an embodiment, the publisher registers with the software bundling service using a self-service website provided by the software bundling service. In an embodiment, the publisher is able to specify basic information about itself such as, for example:
Publisher identifying information, such as name and corporate logo.
Contact information.
Method of payment to publisher of revenues derived from placement of advertiser offers (e.g. by check, to a PAYPAL account, by wire, or by credit card).

In an embodiment, when the publisher registers with the software bundling service, the publisher downloads an offer manager module, such as that described above, and integrates the offer manager module into software installation packages distributed by the publisher. In an embodiment, the offer manager module provides an SDK that enables the publisher's installer to make calls to access services provided by the software bundling service. In an embodiment, the software bundling service provides facilities that allow publishers to create placements for advertisements in their installation processes. In an embodiment, the software bundling service can generate advertisements, and the software bundling service can require the publisher to specify the size of the display area for rendering advertising offers on user PCs.

In the second operation of the method, one or more processes running on a server enable a software advertiser such as, for example, a mobile application developer, to register 1020, over the network, with the software bundling service. In an embodiment, the advertiser registers with the software bundling service using a self-service website provided by the software bundling service. Note that, in an embodiment, a publisher may concurrently register as an advertiser. In an embodiment, the software advertiser is able to specify basic information about itself such as, for example:
Advertiser identifying information, such as name and corporate logo.
Contact information.
Method of payment for placement of advertiser offers (for example, by check, from a PAYPAL account, by wire or by credit card).

In an embodiment, the advertiser can then register their software products, such as mobile applications, with the service, which can include, for example:
Uploading software products to the bundling service (which may, in an embodiment, be omitted for mobile applications (which are, in an embodiment, supplied via an app store).
Providing descriptions of the software products.
Categorizing and defining the software products, for example, software products may be categorized as:
   PC applications.
   Mobile applications.
Submitting the software products for review and approval by the software bundling service.
Providing URLs that can be used to download the product, for example, a URL for a mobile application in a mobile applications store hosted by the bundling service, the software publisher, or a third-party.

Note that while cross-platform bundling, particularly the bundling of PC and mobile applications, is discussed in detail below, the facilities provided by the bundling service herein can support the bundling of software applications directed to a single platform, for example, the bundling of PC-based applications directed to a single user PC.

In the third operation of the method, one or more processes running on a server enable the advertiser to create an offer 1030 for an approved software product, over the network, with the software bundling service. In an embodiment, the software advertiser creates advertising campaigns and offers with the software bundling service using a self-service website provided by the software bundling service.

In an embodiment, the software advertiser first creates an advertising campaign. In an embodiment, the advertiser first enters basic campaign details including, for example:
A selection of an approved product of the advertiser.
A campaign name.
A graphic logo for the campaign.
A product image.

In an embodiment, the advertiser next enters targets for the advertising campaign, which may include, for example:
Campaign start and end dates.
Targeted operating systems, for example:
   MICROSOFT WINDOWS (or versions thereof).
   MAC OS (or versions thereof)
   ANDROID (or versions thereof)
   iPhone (or versions thereof)
Targeted mail clients, for example
   AOL
   OUTLOOK
   THUNDERBIRD
   Various targeted software applications (which could include .NET for example)
   .NET VERSION
The existence of one or more directories on a target system matching a pattern.
Whether browser extensions are enabled on a target system.
Whether the target operating system is 64 bit.
Targeted user groups, such as specific WINDOWS user groups.
Targeted minimum system memory.

In an embodiment, the advertiser next enters bids for the advertising campaign. In an embodiment, bids represent the price the advertiser is willing to pay, per installation, for placing its software product with users via the software bundling service. In an embodiment, bids may include, for example:
A selection of one or more locales, such as, for example, specific countries or regions within countries where a user wishes to offer the product associated with the advertising campaign.
A bid amount for each locale, a portion of which may be distributed to publishers, and a potion of which may be retained by the software bundling service.

In an embodiment, the advertiser next creates an offer under the campaign. In an embodiment, the offer is used to create the advertisement users view on their PCs when the offer is presented to such users. In an embodiment, the software advertiser provide details and features of the product associated with the advertising campaign that may solicit users interest in installing the product, which may include, for example:
An offer name.
A URL that links to a webpage that displays the product's terms of service (typically on a website of the advertiser).
An introduction line.
A description of the offer.

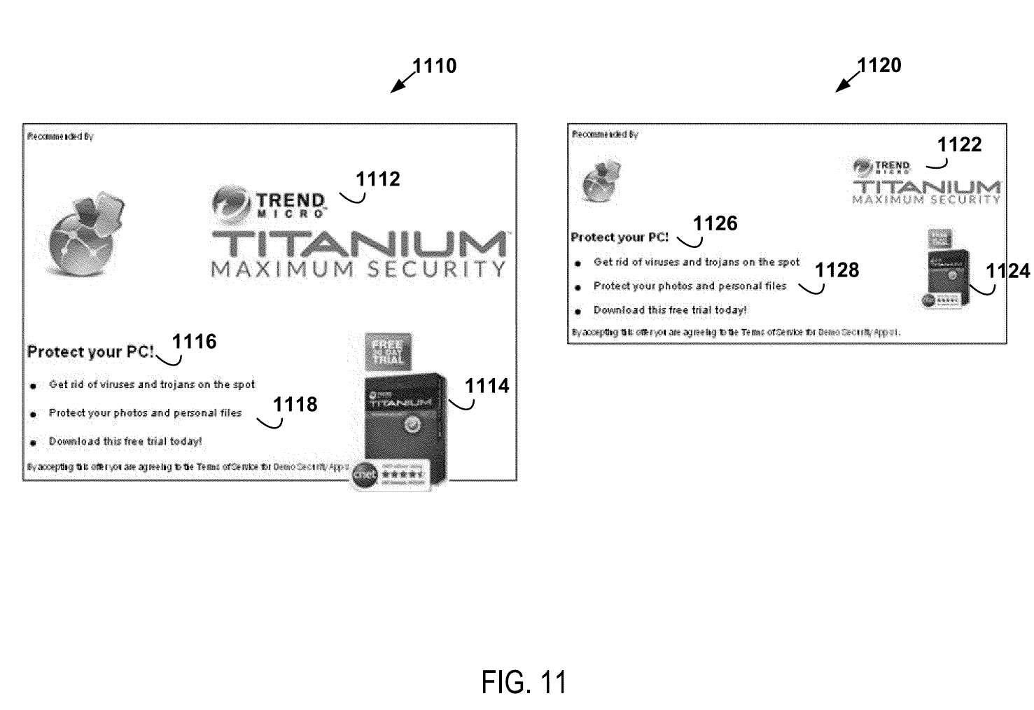

In an embodiment, the software bundling service utilizes this data, along with campaign and product logos to create an advertisement, example of which are presented in FIG. 11 which illustrates embodiments of an advertiser campaign including login and relevant data of the advertiser's software application. In an embodiment, the advertisement may be presented in a large format 1110 or a small format 1120, but in either case, the advertisements 1110 and 1120 include the campaign logo 1112 and 1122, the product image 1114 and 1124, the introduction line 1116 and 1126 and the offer description 1118 and 1128.

In an embodiment, the advertiser then enters payment information for the offer. In an embodiment, the user enters a deposit amount that is charged to the advertiser, for example, via the advertiser's PAYPAL account or via an invoice, which the advertiser pays by check. In an embodiment, the deposit amount is then credited to an advertiser account for the software advertiser maintained by the bundling service. In an embodiment, the software advertiser account is debited by the applicable bid amount when users accept the software advertiser's offer and installs the software advertiser's software product, as described in detail below. In an embodiment, when the deposit account is fully depleted of funds, offers are not presented to users on behalf of the advertiser.

In the fourth operation of the method, one or more processes running on a server enable the publisher to enter into a partnership arrangement 1040 with the advertiser and select the advertiser's offer, over the network, utilizing facilities provided by the software bundling service. In an embodiment, the software advertiser enters into a partnership arrangement with the software advertiser and selects the advertiser offer using a self-service website provided by the software bundling service. In an embodiment, software publishers and software advertisers are automatically matched by the software bundling service for partnership arrangements. In an embodiment, partnerships are matched based on a scoring function applied to the attributes of their products and services. For example, if and advertiser and publisher have no overlap in the locales supported by their products, then the partnership score will be zero. Additionally, the categories associated with each product are pairwise matched with each pair having a weight determined by the historical performance of the category pair in our system. In an embodiment, advertiser offers are automatically weighted and optimized by the software bundling service, for example, based on historical performance data and optimized based on category, application, and other data.

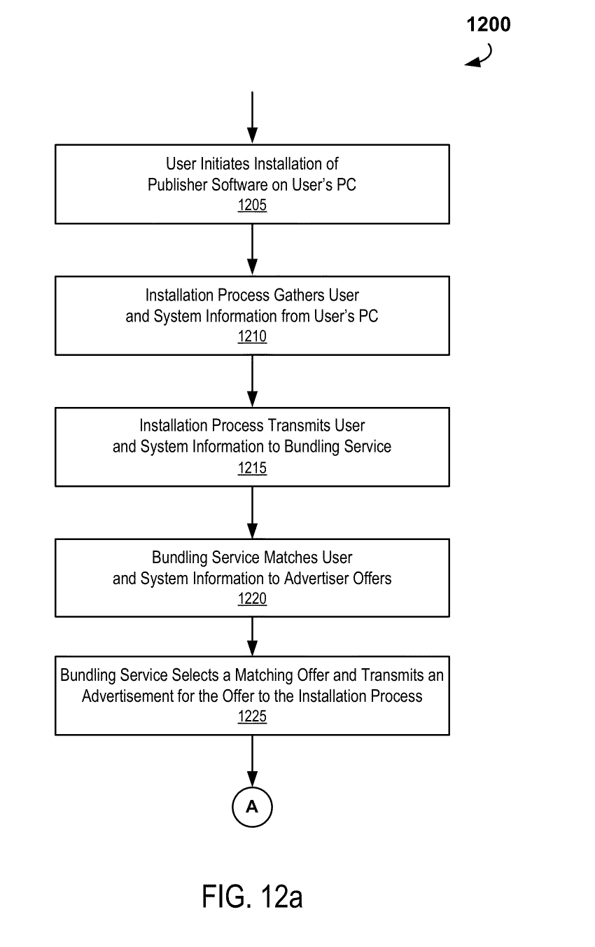

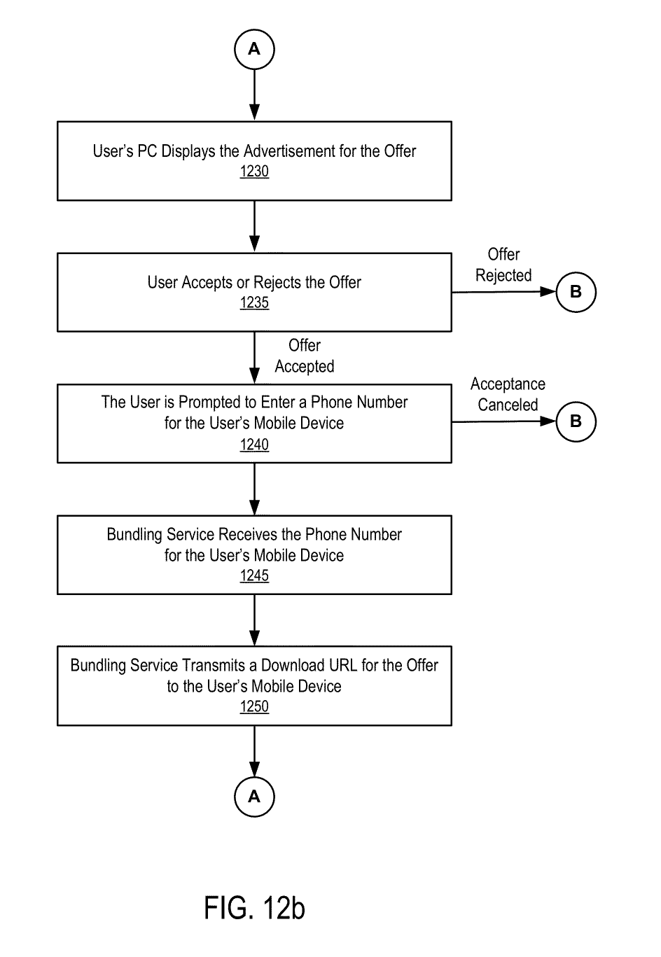

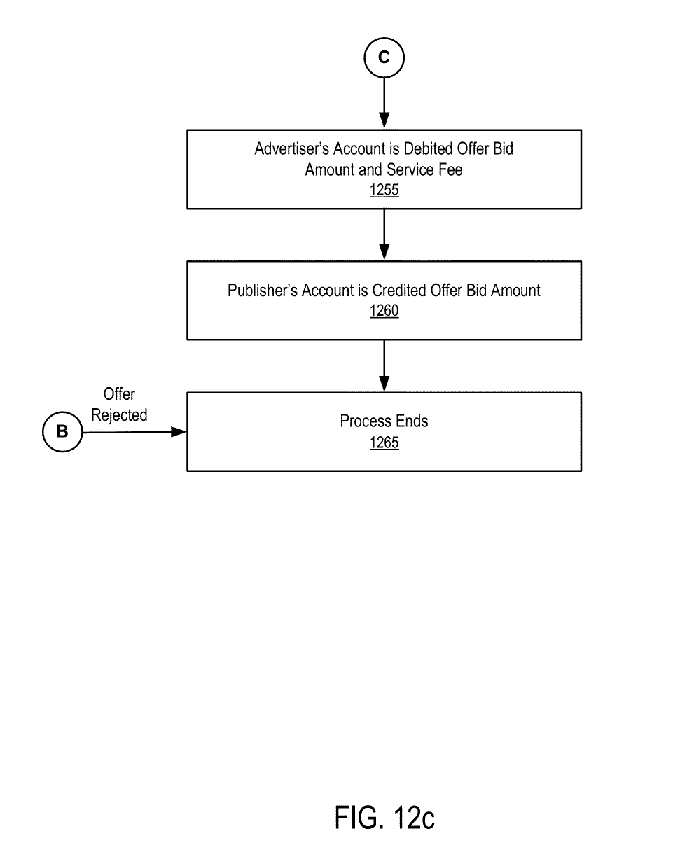

In the fifth operation of the method, one or more processes running on a server present 1050, over the network, the advertiser offer to selected users who may accept the offer and install the advertiser's software on their respective user devices. One embodiment of this operation is described in detail below with respect to FIGS. 12a-c.

FIGS. 12a-c illustrates one embodiment of a method a method for presenting a cross-platform offer for a mobile application bundled, via a software bundling service, with a PC application. In one embodiment, one or more servers such as the software bundling service servers shown in 742 of FIG. 7 or the user devices 722 and/or 724 of FIG. 7 (as noted below) perform the operations of the method shown in FIG. 12a-c (as noted with respect to individual operations), and software bundling service databases such as that shown in 744 of FIG. 7 store the data collected and utilized by the method.

In the first operation of the method, a user initiates installation 1205 of a publisher's software application on the user's PC. In embodiment, the user initiates installation of a software installation package that includes an offer manager module provided by a software bundling service. In an embodiment, the user may have obtained the software installation package via any conventional means, for example, by downloading the package from the publisher's website or a third-party website, or by loading the installation package from a computer-readable medium such as, for example, a CD or a DVD.

In the second operation of the method, at a point in the installation process, the installation process on the user PC gathers 1210 user and system information from the user's PC. In an embodiment, the user and system information is gathered by the offer manager. In an embodiment, the offer manager gathers the information at the same time the publisher's software application is being installed. In an embodiment, the offer manager gathers the information only after the publisher's software application has been successfully installed.

In an embodiment, the user and system information gathered by the offer manager may include, without limitation, one or more of:
The publisher whose software is being installed.
The PC's operating system.
The PC's locale (e.g. country or region).
Mail clients installed on the PC.
Browsers installed on the PC.
Basic, non-personally identifiable characteristics of the user, such as, without limitation:
   User group memberships settings on the PC.
   Administrator status.
   Browser cookies relating to specific domains.
   Mobile device type owned by the user and their respective operating systems.
Software previously installed on the user's PC.
Available disk space and memory on the PC.
The existence of specific files and directories on the PC.
The existence and values of specific registry keys on the PC.

In an embodiment, the installation process does not gather any data relating to the user that could compromise the user's privacy such as, for example, the user's identity, potentially sensitive demographics or financial accounts.

In the third operation of the method, the installation process transmits 1215 all, or a portion, of the user and system information gathered from the user's PC to the bundling service. In an embodiment, the offer manager prepares a summary report that summarizes the user and system information gathered from the user's PC and transmits the summary report to the bundling service.

In the fourth operation of the method, one or more processes running on a server associated with the software bundling service receive the user and system information transmitted by the installation process and match 1220 the information to advertiser offers on the software bundling service. In an embodiment, advertiser offers may be matched if one or more of the following criteria are met:
The advertiser offer is active (e.g., the current date falls between the offer start and end dates).
The advertiser offer is an offering by a partner of the publisher.
The advertiser offer was selected by the publisher.
The advertiser offer is targeted to a locale matching the user's locale.
The advertiser offer is targeted to a platform having properties identified on the user PC, such as, for example, a system having:
   A particular operating system.
   A particular browser.
   A particular directory.
   A particular application
The advertiser offer is targeted to a user with properties identified on the user PC, such as, for example, a user that:
   Belongs to a specific user group setting.
   Is associated with browser cookies for a specific domain.
   Has a particular mobile device type.

In the fifth operation of the method, one or more processes running on a server associated with the software bundling service select 1225 one or more matching advertiser offers and transmits information relating to the offers including, in an embodiment, the advertisements for the offers, to the installation process on the user's PC. In an embodiment, where a single offer is matched, information relating to that offer is transmitted to the installation process on the user's PC, including an advertisement for the selected offer. In an embodiment, when multiple offers are matched, the bundling service selects an ordered set of the matched offers to transmit to the installation process. In an embodiment, the matching advertiser offers with the highest performance rates calculated based on multiple criteria, such as install rate, bounty, targeted operating systems, or other targeted applications, are selected. In an embodiment, the advertisements transmitted to the installation process are built from data on the bundling service relating to the selected offers and each offer may, in an embodiment, comprise an advertisement such as shown in FIG. 11.

In an alternative embodiment, where multiple offers are matched, information relating to multiple offers may be transmitted to the installation process. In an embodiment, the offer manager then evaluates and filters such offers on the user's PC using, for example, user preferences stored locally on the user's PC. In an embodiment, an offer manager on the user's processes the sorted offer list and determines if an offer should be shown. In an embodiment, the determination involves evaluating information on the user's PC with offer meta-data. User software applications or machine settings stored locally on the user's PC are not transmitted to the software bundling service due to security and privacy reasons.

In the embodiment illustrated in FIG. 12a-c, it is presumed that the selected offer relates to a mobile application, although as noted above, the software bundling platform described in the present application can support software bundling directed to the any platform, including the PC on which the installation process is running.

In the sixth operation of the method, the installation process on the user PC receives the information relating to the offer transmitted by the software bundling service and displays 1230 the advertisement for the offer to the user on the user's PC. In an embodiment, an example of the advertisement displayed to the user in an offer window as shown in FIG. 3, such that the window displaying the advertisement 300 provides offer details 310, a hyperlink 320 to a webpage providing terms of service for the mobile application that is the subject of the offer, and user interface controls to accept 330 or reject 340 the advertiser offer.

In the seventh operation of the method, the installation process on the user PC receives an indication from the user that the user accepts or rejects 1235 the offer. If the offer is rejected, the process ends 1265.

If the user accepts the offer, in the eighth operation of the method, the user is prompted 1240 to enter a phone number for the user's mobile device. In an embodiment, a PC-to-mobile module running on the user's PC prompts the user to enter the user's mobile phone number, for example, using a window such as shown in FIG. 4 that is displayed on the user's PC. In an embodiment, the PC-to-mobile module is embedded in the publisher's software installation package, or alternatively, is part of the offer manager module. In an embodiment, the PC-to-mobile module is automatically downloaded and executed from the bundling service when the advertiser offer is accepted

If the user cancels acceptance of the selected offer, for example, by closing 450 the display of the advertisement without entering a mobile number, the process ends 1265. If the user enters a mobile number 430 and indicates the number should be sent to the software bundling service, for example, by selecting a send button 440, the mobile number is transmitted to the software bundling service. In an embodiment, the PC-to-mobile module displays a confirmation page to the user, such as shown in FIG. 5.

In the ninth operation of the method, one or more processes running on a server associated with the software bundling service receive 1245 the user's mobile number and in the tenth operation of the method, the bundling service transmits 1250 a text message to the user's mobile device that includes a hyperlink for a download URL for the mobile application that is the subject of the offer such as shown, for example, in 610 of FIG. 6. In an embodiment, the download URL is directed to the software bundling service and additionally comprises an identification of the selected offer. The user can then use the download URL to download and install the mobile application (not shown in FIG. 12a-c) as described above with reference to FIG. 1.

In the eleventh operation of the method, one or more processes running on a server associated with the software bundling service debit 1255 the offer bid amount (which may include a service fee charged by the bundling service), from an account of the advertiser. In an embodiment, the advertiser account so debited is an advertiser deposit account maintained by the bundling service on behalf of the advertiser. Additionally or alternatively, the advertiser does not have a deposit account with the bundling service, and the bundling service generates an invoice (e.g. in electronic or hardcopy form) with conventional payment terms (e.g. net 30) that is sent to the advertiser via any conventional means that is appropriate (e.g., regular mail or email).

In an embodiment, the advertiser deposit account is debited when the offer is displayed to the user. In an embodiment, the advertiser deposit account is debited when the user initially accepts the offer. In an embodiment, the advertiser deposit account is debited when the user provides a mobile number to the bundling service. In an embodiment, the advertiser deposit account is debited when the bundling service transmits the download URL to the user's mobile device. In an embodiment, the advertiser deposit account is debited when the user uses the download URL to download the mobile application. In an embodiment, the advertiser deposit account is debited when the user starts up the mobile application for the first time on the user's mobile device.

In the twelfth operation of the method, one or more processes running on a server associated with the software bundling service credit 1260 an account of the publisher the offer bid amount. In an embodiment, the publisher account so credited is a publisher deposit account maintained by the bundling service on behalf of the publisher. In an embodiment, the publisher account so credited is an account external to the publishing service, for example. a PAYPAL account or a bank account held by the software publisher. The process 1200 then ends 1265.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations that are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method comprising:
receiving, over a first network, from a first user device associated with a user, information relating to the installation of a first software application on the first user device, wherein the first user device is a platform of a first platform type;
matching, using a computing device, at least a portion of the information relating to the installation of the first software application and other applications and settings on the first user device to an offer for a second software application, wherein the second application is targeted to a second platform type different than the first platform type;
transmitting, over the first network, to the first user device, a representation of the offer for the second application;
receiving, over the first network, from the first user device, an acceptance of the offer for the second application, wherein the acceptance of the offer comprises a communication reference to a second user device accessible via a second network, wherein the second user device is a platform of the second platform type; and
transmitting. over the second network, to the second user device, using the communication reference, a download link for the for the second application.

2. The method of claim 1, wherein the first user device is a personal computer of the user, and the first network an Internet Protocol network, and the second user device is mobile device of the user and the second network is a mobile communications network.

3. The method of claim 1, wherein the download link comprises an identification of the offer and the offer additionally comprises a download location for the second application, the method further comprising:
receiving. over the first network, from the second user device an indication of a user selection of the download link, the indication comprising the identification of the offer;
retrieving, via the computing device, the offer using the identification of the offer; and
causing, over the first network, the second user device to be redirected to the download location for the second application.

4. The method of claim 3, wherein the second user device is not a platform of the second platform type, and the method additionally comprises:
determining, over the first network, that the second user device is not a platform of the second platform type; and
responsive to determining that the second user device is not a platform of the second platform type, the second user device is not caused to be redirected to the download location for the second application.

5. The method of claim 1, wherein the first software application is associated with a software publisher and the second software application is associated with a software advertiser, the method additionally comprising:
charging, using the computing device, the software advertiser a fee; and
remitting, using the computer device, at least a first portion of the fee, to the software publisher.

6. The method of claim 5 additional comprising:
remitting, using the computer device, at least a second portion of the fee, to a software bundling service provider.

7. The method of claim 6, wherein the information relating to the installation of the first software application on the first user device comprises an identification of the software publisher, and matching at least a portion of the information relating to the installation of the first software application and other applications and settings on the first user device to the offer for the second software application comprises determining that the software advertiser is a partner of the software publisher.

8. The method of claim 7, wherein matching at least a portion of the information relating to the installation of the first software application and other software applications and settings on the first user device to the offer for the second software application further comprises determining that the software advertiser has previously selected the offer for presentation to users installing the first software application.

9. The method of claim 1, wherein the information relating to the installation of the first software application on the first user device comprises information stored on the first user device, where such information was gathered by a process that installed the first software application on the first user device.

10. The method of claim 9, wherein the information stored on the first user device gathered by the process that installed the first software application on the first user device comprises a user characteristic, and matching at least a portion of the information relating to the installation of the first software application on the first user device to the offer for the second software application comprises determining that the offer is targeted to users having the user characteristic.

11. The method of claim 10, wherein the user characteristic comprises of a list of user group memberships for the user, an administrator status of the user, user software applications installed, user settings and browser cookies and/or history relating to specific domains.

12. The method of claim 2, wherein the download link is transmitted to the second user device as a hyperlink embedded in a message transmitted to the second user device.

13. The method of claim 3, wherein the message transmitted to the second user device by one of: an SMS message, email.

14. A non-transitory computer-readable storage medium storing computer-readable instructions, which when executed, cause a system to perform:
receiving, over a first network, from a first user device associated with a user, information relating to the installation of a first software application on the first user device, wherein the first user device is a platform of a first platform type;
matching at least a portion of the information relating to the installation of the first software application on the first user device to an offer for a second software application, wherein the second application is targeted to a second platform type different than the first platform type;
transmitting, over the first network, to the first user device, a representation of the offer for the second application;
receiving, over the first network, from the first user device, an acceptance of the offer for the second application, wherein the acceptance of the offer comprises a communication reference to a second user device accessible via a second network, wherein the second user device is a platform of the second platform type; and
transmitting. over the second network, to the second user device, using the transmitting. over the second network, to the second user device, using the communication reference, a download link for the for the second application.

15. A computer system comprising:
a memory; and
a processor coupled to the memory to:
receive, over a first network, from a first user device associated with a user, information relating to the installation of a first software application on the first user device, wherein the first user device is a platform of a first platform type;
match at least a portion of the information relating to the installation of the first software application on the first user device to an offer for a second software application, wherein the second application is targeted to a second platform type different than the first platform type;
transmit, over the first network, to the first user device, a representation of the offer for the second application;
receive, over the first network, from the first user device, an acceptance of the offer for the second application, wherein the acceptance of the offer comprises a communication reference to a second user device accessible via a second network, wherein the second user device is a platform of the second platform type; and
transmit. over the second network, to the second user device, using the transmitting. over the second network, to the second user device, using the communication reference, a download link for the for the second application.
